(19) United States
(12) Patent Application Publication
(10) Pub. No.: US 2007/0063583 A1
(43) Pub. Date: Mar. 22, 2007

(54) Crawlertrack for a ski trail grooming machine and production method

(76) Inventor: Walter Nuesch, Arnegg (CH)

Correspondence Address: SCHWEITZER CORNMAN GROSS & BONDELL LLP, 292 MADISON AVENUE - 19th FLOOR, NEW YORK, NY, 10017, US

(21) Appl. No.: 11/543,639

(22) Filed: Oct. 5, 2006

Related U.S. Application Data
(63) Continuation of application No. PCT/CH04/00194, filed on Mar. 31, 2004.

(51) Int. Cl. B62D 55/24

(52) U.S. Cl. 305/165

(57) ABSTRACT

A crawlertrack for a ski trail grooming machine comprises a number of parallel belts joined to one another by cross members. Each belt is made of an elastomer reinforced by a textile carcass. The belt has a row of holes for attaching the cross member. The supporting warp threads of the carcass are made of aramid and flatly extend parallel to the outer sides of the belt.

The present invention is a continuation of PCT/CH2004/000194 filed 31 Mar. 2004.

### BACKGROUND OF THE INVENTION

Caterpillars for ski-run vehicles consist of several parallel belts which are connected together with lateral carriers. Conventional belts of this kind consist of an elastomer which is reinforced by a textile carcass. These known carcasses consist of several bands layed one over another of polyamide webs. The useful life of such belts is approximately one fifth of the useful life of the ski-run track vehicle.

The present invention aims at increasing the life-span of such belts. This task is solved by the combination of features of the claims.

### BRIEF DESCRIPTION OF THE INVENTION

In accordance with the foregoing, the present invention comprises a crawlertrack belt of an elastomer reinforced by a textile carcass. The belt has at least one row of cylindrical holes extending in a longitudinal direction. Laterally-extending carriers are fastened to the belt through the holes. The carcass comprises at least one web with bearing warps arranged parallel to each other and are shaped and parallel with respect to the outside surfaces of the belt. The warps are of an aramid construction.

Because aramid has a much higher tension strength than polyamide, the carcass can be much thinner. This improves the alternating bending stability significantly. Thus, the useful life of the belts is considerably improved. By the considerably higher stiffness of aramid compared with polyamide, the danger of injury when a belt tears is considerably reduced and the load distribution on the various belts of the caterpillar is improved.

Preferably the bearing warp yarns consist of several twines and are twisted in a sense contrary to twist the twines. The twines are twisted in the same sense as the threads or yarns from which they are found. At an equal number of windings per meter the result is that the yarn filaments in the center of the twines are approximately parallel to the length direction of the twines. This results in the highest possible strength and stiffness of the twines.

A particularly high life duration is achieved when all of the bearing aramid-yarns are arranged in a single plane, i.e. in a single layer of the web. This results in an even distribution of the load on all bearing yarns, as well over guide rollers or drive rollers. The elastomer layer on the outside of the belt is preferably thicker than on the inside for wear considerations.

For manufacturing of the belt, the carcass is soaked with liquid epoxy resin and thereafter used such that a thin epoxy layer of about 1% of the weight of the carcass surrounds the carcass. A latex solution adapted to the elastomer to be applied is then applied to the carcass. After curing, the latex layer surrounds the carcass with a level of at least 10% of the weight of the carcass. Onto this latex layer the elastomer is vulcanised on both sides at about 160° C. by calendering.

The manufacturing method described above results in a particularly durable connection between the carcass and the elastomer. The through holes of the at least one row of holes are preferably cut by a high pressure water jet. Conventionally these holes are punched, which results in frayed hole edges and irregular hole walls. These disadvantages can be avoided by water jet cutting. The load transfer between the belt and the lateral carriers is thereby improved.

### BRIEF DESCRIPTION OF THE DRAWINGS

An exemplary embodiment of the invention is hereinafter described with reference to the drawings, in which

FIG. 1 shows a perspective view of caterpillar belt of a ski-run track vehicle;

FIG. 2 shows a longitudinal section through a caterpillar belt;

FIG. 3 shows a partial view of a carcass; F.

FIG. 4 shows the structure of the twines;

FIG. 5 shows the structure of a cord yarn;

FIG. 6 shows a further embodiment of the belt in a lateral section; and

FIGS. 7 and 8 show two variants of the connection of two belt ends to form an endless belt in longitudinal section.

### DETAILED DESCRIPTION OF THE INVENTION

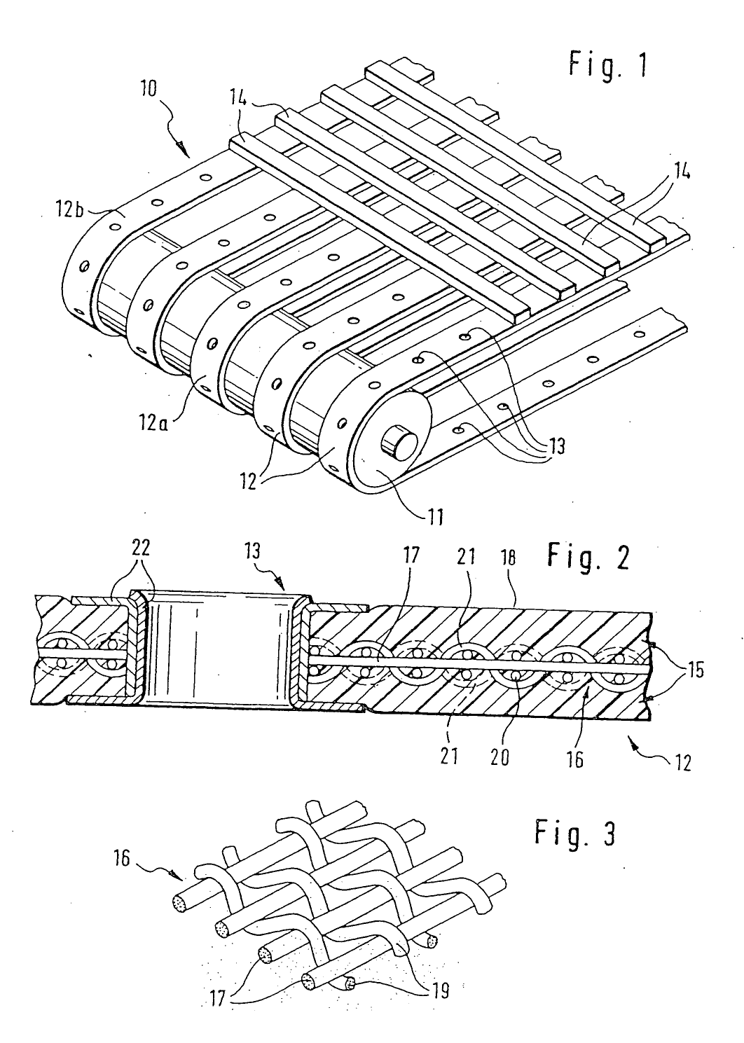

FIG. 1 shows schematically the structure of a caterpillar 10 of a ski-track vehicle. The caterpillar 10 is guided over two rollers 11 spaced from one another, of which one is connected to a drive unit. The caterpillar 10 comprises several parallel belts 12 each having at least one row of throughgoing holes or orifices 13. Lateral carriers 14 of aluminium are screwed to each of the belts 12 through the holes. The longitudinal extension of the carriers 14 extends parallel to the axis of the rollers 11.

Each belt 12 consists of an elastomer 15 in which a textile carcass 16 is embedded. In the embodiment shown in FIGS. 2 and 3, the carcass 16 consists of a single web layer in which bearing warps 17 are unwaved and lie parallel to the outside surfaces 18 of the belt 12 and consist of an aramid. In the embodiment of FIG. 3, the warps 17 are connected together by wefts 19 of a polyamide. In the example of FIG. 2, the carcass has linearly throughgoing wefts 20 on both sides of the warps 17. On one side of the warps 17 these linearly extending wefts could also consist of an aramid. This results in a particularly high resistance to piercing of the carcass 16. The wefts 20 are connected together by further warps 21 of a polyamide. These waved warps 21 contribute practically nothing to the longitudinal strength but serve to hold the carcass 16 together. As shown in FIG. 2, the orifices 13 may be reinforced by tubular rivets 22.

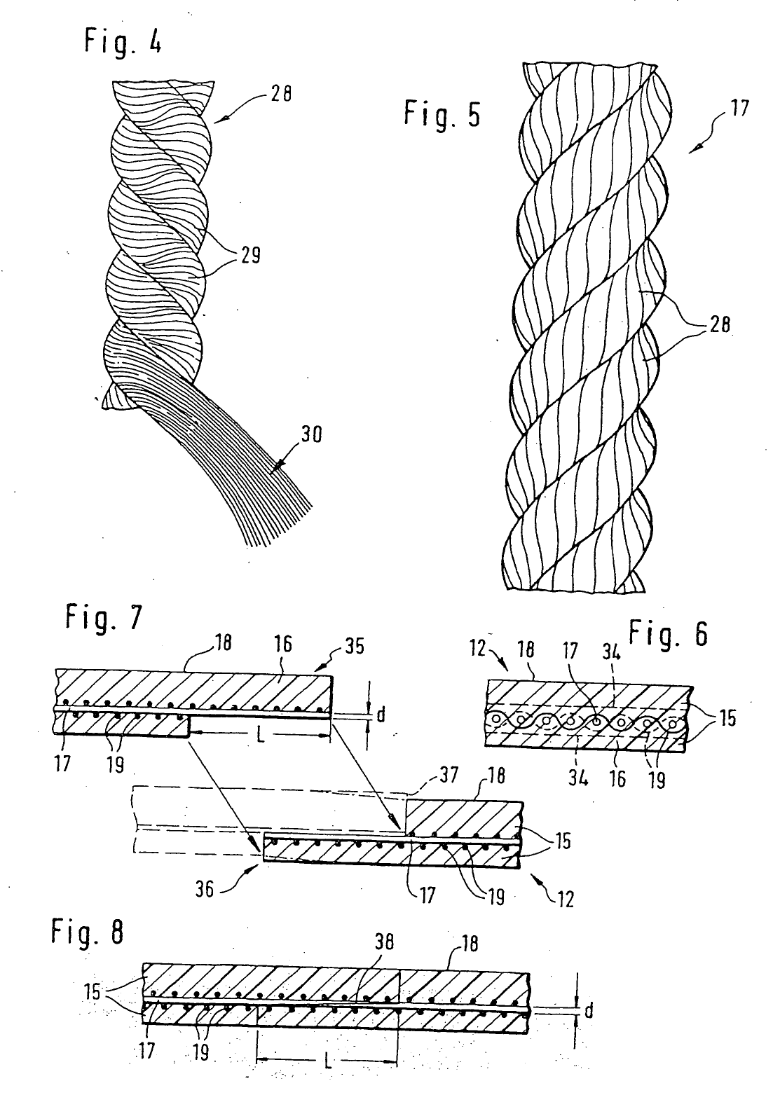

FIGS. 4 and 5 show the structure of the bearing warps 17. The warp 17 of FIG. 5 is a cord which is wound in the opposite sense than the twines 28 of FIG. 4 from which it is formed. In the represented embodiment the cord is wound clockwise or Z, whereas the twines 28 are wound counter clockwise or S. The three yarns 29 of a twine 28 are wound in the same sense as the twine 28, in the example shown counter clockwise or S. Each yarn 29 consists of several hundred, e.g. about one thousand aramid filaments 30. The winding number of the filaments 30 per meter in the yarn 29 is approximately equal to the number of windings per meter of the yarn 29 in the twine 28, and (at least for the middle belts 12a of the caterpillar 10) approximately equal to the windings per meter of the twines 28. This results in the highest possible strength and stiffness of the bearing warps 17. The number of windings is exaggerated in the drawing. 60 windings per meter have shown to be optimal. For the outermost belt 12b of the caterpillar 10 of the ski-track vehicle the winding number of the twines 28 in the warps 17 is preferably somewhat higher. Thereby the stiffness of these belts is lower than those of the middle belts 12a. This can be of advantage in turns.

A further embodiment is shown in FIG. 6 in lateral section. The carcass 16 consists in this case of a web according to FIG. 3 in which the wefts 19 are considerably thinner than the warps 17, and additionally with a covering web 34 on each side of first web of a polyamide, aramid, or polyester. The covering web 34 is coated with an elastomer on both sides. Instead of the covering web, an elastomer foil can be used, e.g. one with short fibers of an aramid.

As depicted in FIGS. 7 and 8, for manufacturing of the endless belts, the ends 35, 36 of the belt of e.g. 10 m length with the structure described are ground down on opposite sides over a length L of e.g. 30 cm parallel to the outside surfaces 18 to the bearing warps 17. The two ends 35, 36 are then vulcanised together over the length L such that the warps 17 of the two ends 35, 36 touch. Thereby, a tensile strength of over 70% of the one of the belts is achieved.

With conventional belts with several layers of reinforcing webs the above described method of connection is not possible. In conventional belts the belt ends are either connected by hinges or by finger splicing. All these connections do not reach the strength of the described overlapping splicing.

With the described overlapping splicing there results a step 37 on both outer surfaces 18 of the height of the diameter d of the bearing warps 17. In the application of caterpillars for ski-track vehicles, these steps hardly disturb operation. In other applications it may be advantageous to grind off these steps 17, which is shown schematically in FIG. 7 in phantom.

An even stronger connection results when the grinding surfaces 38 are tilted by a small angle d/L against the outer surfaces 18, as shown in FIG. 8. Thereby the steps 37 are avoided. The bending strength of the belts is constant even over the connecting region. The angle d/L is preferably approximately 0.05°, and in any case smaller than 0.5°. The grinding surfaces 38 are still approximately parallel to the outside surfaces, in contrast to conventional tilted splicings.

We claim:

1. A belt for a caterpillar or a ski-track vehicle, comprising an elastomer reinforced by a textile carcass, wherein the belt has at least one row of cylindrical holes in a longitudinal direction for fastening lateral carriers of the caterpillar, characterized in that the carcass has at least one web with bearing warps arranged parallel to each other and straight and parallel to outside surfaces of the belt and comprise an aramid.

2. The belt according to claim 1, wherein the bearing warps comprise wound cords which comprise a plurality of twines formed of wound yarns, the twines being wound contrary to the winding direction of the cords, and wherein the twines are wound in the same sense as the yarns (29).

3. The belt according to claim 2, wherein the yarns are formed of wound filaments and number of windings of the filament per meter of yarn is approximately equal to the number of windings per meter of the yarns in the twine.

4. The belt according to claim 1, 2, or 3, wherein the bearing warps of the carcass are arranged in a common layer.

5. The belt according to claim 4, wherein the belt has two ends connected together at a connecting region of length L to form an endless belt, characterised in that that at the connecting region both ends of the belt are ground off from opposite sides approximately parallel to the outside surfaces (18) over the same length L, and that the belt ends are vulcanized together in an overlapped manner over the length L.

6. The belt according to claim 1, 2 or 3, wherein the carcass is coated with a synthetic resin to which the elastomer holds.

7. The belt according to claim 6 wherein the weight of the coated resin is less than 4% of the weight of the carcass.

8. The belt according to claim 1, 2 or 3, wherein the holes are formed by a high pressure water jet and are reinforced by tubular rivets.

9. The belt according to claim 1, 2 or 3, wherein the elastomer layer is thicker on one side of the carcass than on the other.

10. A caterpillar for a ski-track vehicle comprising at least one middle belt and two outer belts according to claim 1, 2 or 3 arranged in a parallel fashion, the belts being connected together by the lateral carriers, characterized in that the elasticity of the outer belts is greater than the elasticity of the middle belts.

11. A method of manufacturing of a belt according to claim 1, 2 or 3, comprising the steps of coating the carcass with an artificial resin which is partially hardened and thereafter applying a latex solution which is partially solidified; vulcanizing an elastomer layer on both sides of the carcass; and then cutting the orifices.
